(19) United States
(12) Patent Application Publication
(10) Pub. No.: US 2012/0036463 A1
(43) Pub. Date: Feb. 9, 2012

(54) METRIC NAVIGATOR

(76) Inventors: Dmitri I. KRAKOVSKY, San Francisco, CA (US); Shankar P. NARAYAN, Redwood City, CA (US); Kira LETSKINA, San Carlos, CA (US)

(21) Appl. No.: 12/907,876

(22) Filed: Oct. 19, 2010

Related U.S. Application Data
(60) Provisional application No. 61/371,632, filed on Aug. 6, 2010.

(51) Int. Cl. G06F 3/048

(52) U.S. Cl. 715/771

(57) ABSTRACT

Embodiments of the invention provide a software framework for hierarchically organizing individuals or other objects. For example, the software framework may be configured to hierarchically organize employees at a company. One embodiment provides a technique to aggregate one or more metrics associated with the individuals or objects and display the results in a user-friendly manner.

### CROSS-REFERENCE TO RELATED APPLICATIONS

This application claims benefit of U.S. provisional patent application Ser. No. 61/371,632, filed on Aug. 6, 2010, which is hereby incorporated herein by reference.

### BACKGROUND

1. Field of the Invention

The present invention relates to the field of computer software and, in particular, to a system and method for implementing a metric navigator.

2. Description of the Related Art

Organizations constantly strive to collect different business execution metrics with respect to various divisions, departments, and people using various tools like Excel, Email, databases, and others. Typically, these metrics are computed in spreadsheets or reports for data analysis.

However, metrics analyzed on spreadsheets are time-consuming to maintain and become obsolete very quickly. In addition, these metrics analyzed in a spreadsheet do not provide the complete context of the organization, division, or department.

Accordingly, there remains a need in the art for a technique that addresses the drawbacks and limitations discussed above.

### SUMMARY

Embodiments of the invention provide a method for generating a user interface that includes organizational data. The method includes receiving data associated with a hierarchical organization; receiving individual entity information associated with nodes included in the hierarchical organization; receiving a selection of a first individual entity; aggregating one or more metrics associated with the individual entity; and causing the one or more metrics to be displayed on a display device.

One advantage is that embodiments of the invention allow users to quickly and easily aggregate one or more metrics associated with a hierarchical structure.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a networked computer environment in which embodiments of the invention may be practiced.

FIG. 2 is a block diagram of a system configured to implement one or more aspects of the invention.

FIG. 3 is a conceptual diagram illustrating a framework 300 for implementing a metric navigator, according to one embodiment of the invention.

FIG. 4 is a flow diagram of method steps for displaying aggregated values associated with one or more metrics, according to one embodiment of the invention.

FIG. 5 is conceptual diagram of an organizational hierarchy converted to a two-dimensional table, according to one embodiment of the invention.

FIGS. 6-8 are screenshots illustrating a graphical user interface (GUI) for displaying aggregated values associated with one or more metrics, according to various embodiments of the invention.

### DETAILED DESCRIPTION OF EXEMPLARY EMBODIMENTS

Embodiments of the invention provide a software framework for hierarchically organizing individuals or other objects. For example, the software framework may be configured to hierarchically organize employees at a company. One embodiment provides a technique to aggregate one or more metrics associated with the individuals or objects and display the results in a user-friendly manner. For example, various employee metrics can be aggregated for employees that report to a particular individual. Examples of the metrics may include average salary, head count, diversity, turnover, or any other metric. Some metrics may be aggregated as a summation, e.g., head count, while other metrics may be calculated as an average, e.g., average salary.

Also, in some embodiments, the metric navigator may be configured to aggregate metrics at one or more levels of the hierarchy. For example, the metric navigator may aggregate (i) metrics for all of the individuals that directly report to a particular person (i.e., one level deep in the hierarchy), (ii) metrics for a first set the individuals that directly report to a particular person and metrics for a second set individuals that that directly report to the individuals in the first set (i.e., two levels deep in the hierarchy), (iii) metrics for all of the individuals that are below a particular individual in the hierarchy (i.e., all levels below in the hierarchy), or (iv) metrics for any number of layers below a particular individual in the hierarchy.

The organizational metrics may be displayed on a display device in a manner that is easy for the user to understand. Also, in some embodiments, a user may dynamically update a hierarchically-arranged organizational tree to move individuals in the tree, add individuals to the tree, or remove individuals from the tree. The metric navigator may also be configured to dynamically update the metrics relating to elements of the hierarchical organizational tree in response the update of the hierarchical organizational tree.

Some embodiments of the invention provide a technique for specifying organizational metrics and their aggregation rules through metadata, which can be specified in XML (Extensible Markup Language) configuration files or Excel-based template files. Embodiments also specify a methodology to dynamically extract various organization metrics from different data sources and aggregate them on the fly to visualize in the context of the organizational chart.

### Hardware Overview

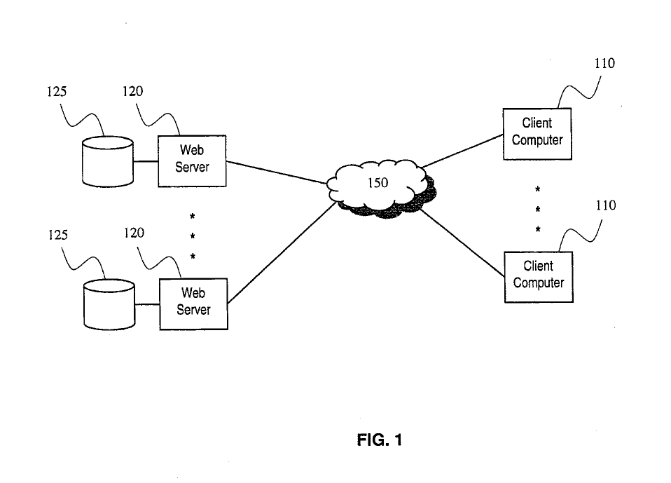

FIG. 1 illustrates a networked computer environment in which embodiments of the invention may be practiced. As shown, the networked computer environment includes a plurality of client computers 110 (only two of which are shown) and a plurality of web servers 120 with associated content storage units 125. The client computers 110 and the web server computers 120 are connected over a computer network 150, e.g., the Internet.

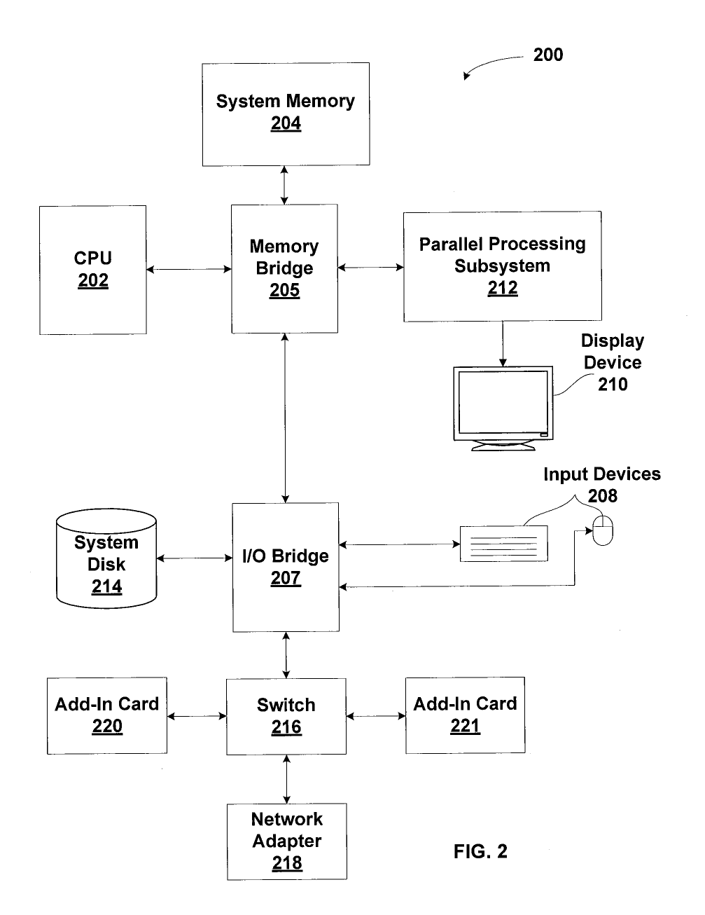

Each client computer 110 includes conventional components of a computing device, e.g., a processor, system memory, a hard disk drive, input devices such as a mouse and a keyboard, and output devices such as a monitor, as illustrated in FIG. 2. Each web server 120 includes a processor and a system memory (not shown), and manages the contents stored in its respective content storage unit using a relational database software. The web server is programmed to communicate with the client computers 110 and other web servers using the TCP/IP protocol. The client computers 110 are programmed to execute web browser programs and other software applications and access the web pages and/or applications managed by the web servers by specifying a uniform resource locator (URL) for the web server into the browser.

In the embodiments of the present invention described below, users are respectively operating the client computers 110 that are connected to the web servers 120 over the Internet. The web pages that are displayed to a user are transmitted from the web servers 120 to that user's client computer 110 and processed by the web browser program stored in that user's client computer 110 for display through the monitor of that user's client computer 110.

FIG. 2 depicts one architecture of a system 200 within which embodiments of the present invention may be implemented. According to various embodiments, the system 200 described in FIG. 2 comprises one implementation of the client computers 110 and/or the web servers 120 described in FIG. 1. Persons having ordinary skill in the art would appreciate that the system 200 in no way limits or is intended to limit the scope of embodiments of the present invention.

System 200 may be a personal computer, smart phone, touch pads, touch screens, or any other device suitable for practicing one or more embodiments of the present invention.

As shown, system 200 includes a central processing unit (CPU) 202 and a system memory 204 communicating via a bus path that may include a memory bridge 205. CPU 202 includes one or more processing cores, and, in operation, CPU 202 is the master processor of system 200, controlling and coordinating operations of other system components. System memory 204 stores software applications and data for use by CPU 202. CPU 202 runs software applications and optionally an operating system. Memory bridge 205, which may be, e.g., a Northbridge chip, is connected via a bus or other communication path (e.g., a HyperTransport link) to an I/O (input/output) bridge 207. I/O bridge 207, which may be, e.g., a Southbridge chip, receives user input from one or more user input devices 208 (e.g., keyboard, mouse, joystick, digitizer tablets, touch pads, touch screens, still or video cameras, motion sensors, and/or microphones) and forwards the input to CPU 202 via memory bridge 205.

A display processor 212 is coupled to memory bridge 205 via a bus or other communication path (e.g., a PCI Express, Accelerated Graphics Port, or HyperTransport link); in one embodiment display processor 212 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 204.

Display processor 212 periodically delivers pixels to a display device 210 (e.g., a screen or conventional CRT, plasma, OLED, SED or LCD based monitor or television). Additionally, display processor 212 may output pixels to film recorders adapted to reproduce computer generated images on photographic film. Display processor 212 can provide display device 210 with an analog or digital signal.

A system disk 214 is also connected to I/O bridge 207 and may be configured to store content and applications and data for use by CPU 202 and display processor 212. System disk 214 provides non-volatile storage for applications and data and may include fixed or removable hard disk drives, flash memory devices, and CD-ROM, DVD-ROM, Blu-ray, HD-DVD, or other magnetic, optical, or solid state storage devices.

A switch 216 provides connections between I/O bridge 207 and other components such as a network adapter 218 and various add-in cards 220 and 221. Network adapter 218 allows system 200 to communicate with other systems via an electronic communications network, and may include wired or wireless communication over local area networks and wide area networks such as the Internet.

Other components (not shown), including USB or other port connections, film recording devices, and the like, may also be connected to I/O bridge 207. For example, an audio processor may be used to generate analog or digital audio output from instructions and/or data provided by CPU 202, system memory 204, or system disk 214. Communication paths interconnecting the various components in FIG. 2 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

It will be appreciated that the system shown herein is illustrative and that variations and modifications are possible. The connection topology, including the number and arrangement of bridges, may be modified as desired. For instance, in some embodiments, system memory 204 is connected to CPU 202 directly rather than through a bridge, and other devices communicate with system memory 204 via memory bridge 205 and CPU 202. In other alternative topologies display processor 212 is connected to I/O bridge 207 or directly to CPU 202, rather than to memory bridge 205. In still other embodiments, I/O bridge 207 and memory bridge 205 might be integrated into a single chip. The particular components shown herein are optional; for instance, any number of add-in cards or peripheral devices might be supported. In some embodiments, switch 216 is eliminated, and network adapter 218 and add-in cards 220, 221 connect directly to I/O bridge 207.

### Metric Navigator

As described, embodiments of the invention provide a software framework for hierarchically organizing individuals or other objects. For example, the software framework may be configured to hierarchically organize employees at a company. One embodiment provides a technique to aggregate one or more metrics associated with the individuals or objects and display the results in a user-friendly manner. For example, various employee metrics can be aggregated for employees that report to a particular individual. Examples of the metrics may include average salary, head count, diversity, turnover, or any other metric. Some metrics may be aggregated as a summation, e.g., head count, while other metrics may be calculated as an average, e.g., average salary.

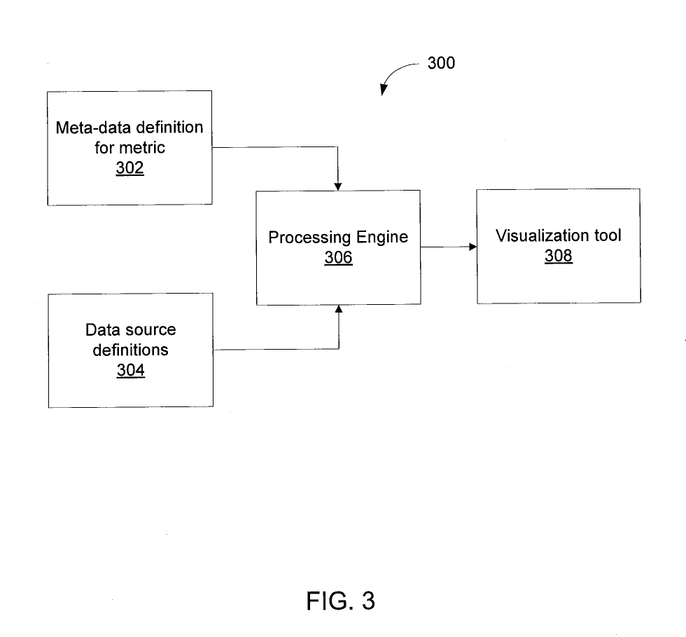

FIG. 3 is a conceptual diagram illustrating a framework 300 for implementing a metric navigator, according to one embodiment of the invention. As shown, the framework 300 includes a meta-data definition for one or more metrics 302, data source definitions 304, a processing engine 306, and a visualization tool 308.

The data source definitions 304 can be of any type, including XML (Extensible Markup Language) files, CSV (comma-separated values) files, Excel files, a database, web service, or the like. Any additional and/or proprietary type of data source can also be created if an additional adapter is provided that conforms to the specifications of the additional data source. Hierarchical organization data and individual entity data included in the hierarchical organization can be extracted from the data source definitions 304. For example, the hierarchical organization may comprise a corporation having a hierarchical structure and the individual entity data may comprise the information stored about each employee of the corporation.

In one embodiment, a mapping schema is provided to extract data from the data source definitions 304. The mapping schema defines attributes that assist in the metrics definition. The processing framework 306 is configured to derive one or more metrics based on the data source definitions 304 and meta-data associated with definitions for the one or more metrics 302. In one embodiment, the metric can be derived using any technically feasible expression language, such as SQL (Structured Query Language). For example, if the metric being analyzed is a salary value, then a mapping schema may be configured to extract salary values from the data source definitions 304 using an SQL query.

In some embodiments, an expression having one or more rules may be provided for inclusion and/or exclusion of individual nodes from the hierarchical tree based on certain values of attributes. For example, in a corporate employee implementation, new employees, e.g., those employees that joined within the last six months, may be excluded from a performance index metric since performance data may not be available for the new employees. Another example of an inclusion and/or exclusion expression is one that includes only individuals that work at a particular office location.

In addition, some metrics may be derived from one or more other metrics. Some metrics may be associated with one or more particular groups or divisions within the hierarchical structure, but not associated with one or more other particular groups or divisions. For example, a metric related to the HR (human resources) department of a corporation may not be relevant for the engineering department. In some embodiments, security rules can be specified to hide nodes from being displayed based on the hierarchical data and the fact sheet.

In one embodiment, metrics can be categorized as “process metrics” or “static metrics.” Process metrics are associated with any item that has a start and an end. Examples include projects with checkpoints, goals, etc. Accordingly, the process metrics can describe how many individual entities are at which stage of the process. Based on the process metrics, the software framework is able to determine, for example, which individuals are ahead of the goals of the process and which individuals are behind. Static metrics are associated with statistics about individual entities. Static metrics can take on many data types, including numbers, percentages, ratios, text, and any other technically feasible data type.

Once the metrics calculations are performed, the processing framework 306 causes one or more aggregated metrics to be displayed in a user interface using the visualization tool 308. In some embodiments, the metric navigator may be configured to aggregate metrics at one or more levels of the hierarchy. For example, the metric navigator may aggregate (i) metrics for all of the individuals that directly report to a particular person (i.e., one level deep in the hierarchy), (ii) metrics for a first set the individuals that directly report to a particular person and metrics for a second set individuals that that directly report to the individuals in the first set (i.e., two levels deep in the hierarchy), (iii) metrics for all of the individuals that are below a particular individual in the hierarchy (i.e., all levels below in the hierarchy), or (iv) metrics for any number of layers below a particular individual in the hierarchy.

The organizational metrics may be displayed on a display device in a manner that is easy for the user to understand. Also, in some embodiments, a user may dynamically update the hierarchical tree to move individuals in the tree, add individual entities to the tree, or remove individual entities from the tree. The metric navigator may also be configured to dynamically updating the metrics relating to elements of the organizational tree in response the update of the entities included in the hierarchical tree.

The manner in which the metrics are displayed may depend on the data type of the aggregated metric, e.g., a plain number, text, a percentage, a ratio, a list, a graph, among others. Depending on the metric, each metric can specify its output type. Metrics may be positive or negative (e.g., retention and attrition) and visualization rules can specify the sort order based on the metric. In some embodiments, visualization rules can also specify the color coding based on metric value. For example, a “used disk space” percentage metric can be specified as 0% to 70% shown in green, 71% to 90% shown in yellow, and 91% to 100% shown in red.

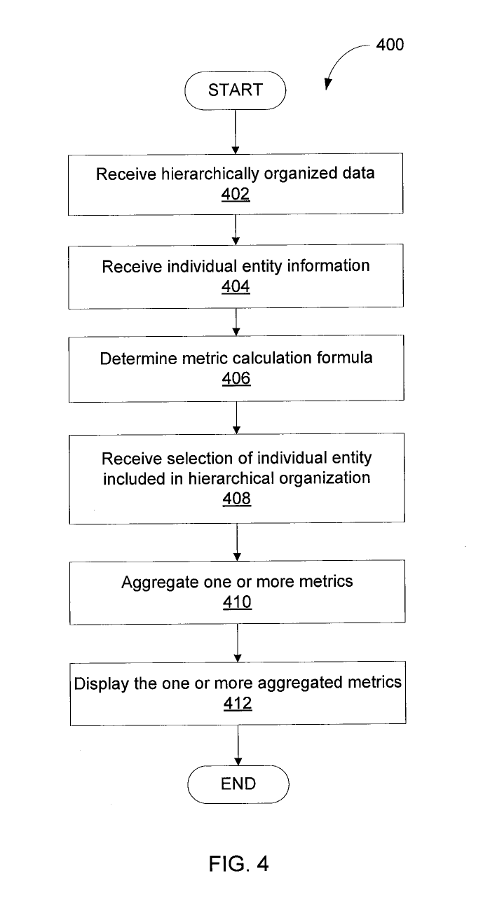

FIG. 4 is a flow diagram of method steps for displaying aggregated values associated with one or more metrics, according to one embodiment of the invention. Persons skilled in the art will understand that, even though the method 400 is described in conjunction with the systems of FIGS. 1-3, any system configured to perform the method steps, in any order, is within the scope of embodiments of the invention.

As shown, the method 400 begins at step 402, where a processor receives hierarchical organization data. The processor is included in a computer system, such as a web server or client computer. The hierarchical organization data can be of any type, including XML (Extensible Markup Language) files, CSV (comma-separated values) files, Excel files, a database, a web service, or the like.

At step 404, the processor receives individual entity information. The individual entities are arranged in the hierarchical organization. As described, one example of a hierarchical organization having individual entities is a corporation with hierarchically-arranged employees.

At step 406, the processor determines a metric calculation formula. The metric calculation formula is used to extract and/or compute the metric from the individual entity information. In some embodiments, the metric calculation formula is a simple pass-though. For example, the age metric may be extracted directly from the individual entity information associated with an individual entity. In other embodiments, the metric calculation formula comprises a mathematical computation using two or more pieces of information included in the individual entity information. For example, a “total compensation” metric may be comprised of the sum of salary data and bonus data.

At step 408, the processor receives a selection of an individual entity included in the hierarchical organization. In one embodiment, a graphical user interface (GUI) is provided that allows a user to select an individual included in the hierarchical organization. The user can navigate up and down in the hierarchical organization to locate the desired individual.

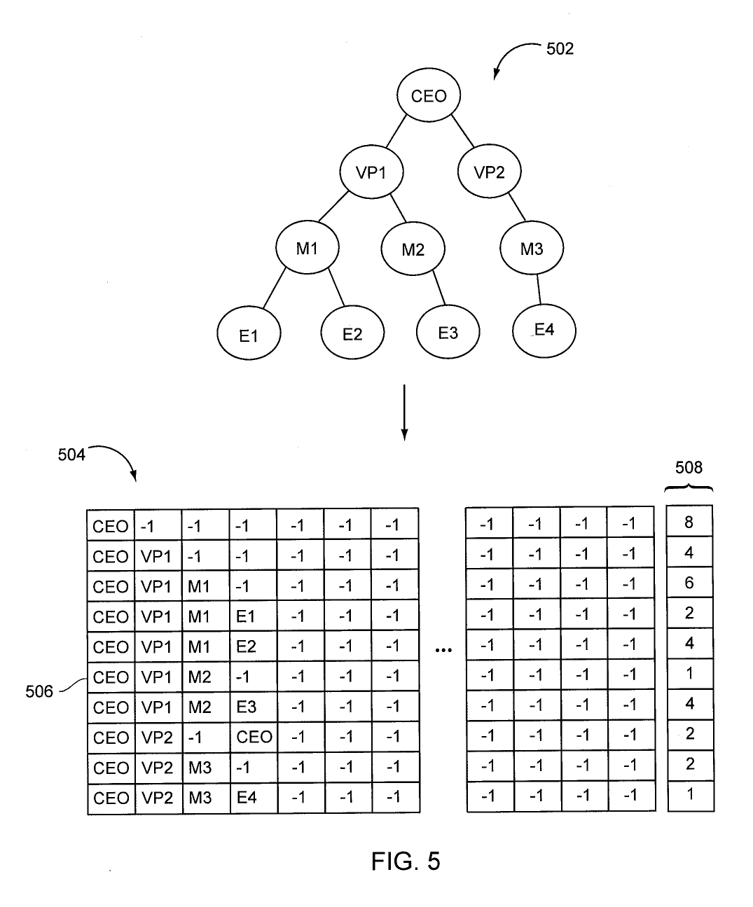

FIG. 5 is conceptual diagram of an organizational hierarchy 502 converted to a two-dimensional table 504, according to one embodiment of the invention. As shown, the organizational hierarchy 502 includes a CEO (chief executive officer) at the top level of hierarchy. The next level includes two vice presidents, VP1 and VP2. Managers M1 and M2 are subordinate to vice presidents VP1, and manager M3 is subordinate to vice president VP2. Employees E1 and E2 are subordinate to manager M1, employee E3 is subordinate to manager M2, and employee E4 is subordinate to manager M3.

In one embodiment, the individual entity information associated with each node in the hierarchical organization may be implemented as one or more tables 504, as shown in FIG. 5. Each row of the table 504 corresponds to a different individual entity. The columns of the table 504 correspond to the different levels of the organizational hierarchy 502. As shown, the columns traverse the organizational hierarchy 502 from left-to-right, with the CEO being in the left-most column. One or more columns 508 can be added to the table following the node-based information to store values for one or more parameters or statistics associated with each individual entity. The value in column 508, for example, may identify the tenure in years for each individual entity. In the example shown at line 506, manager M2 has 4 years of tenure with the company.

For each individual entity, the chain of command from the individual entity up to the top-most node is encoded in the table 504. Within a particular row, individual entities to the left of a particular entry are “up” the hierarchy relative to the particular entry, and individual entities to the right of a particular entry are “down” the hierarchy relative to the particular entry. When a particular entry has a default value, such as “-1,” to the right of the particular entry, that indicates that the particular row identifies the individual entity in the right-most column that does not have a default value. For example, row 506 identifies manager M2.

Using a table, such as table 504, allows the processor to quickly determine the level in the hierarchy of a particular individual entity by determining which column includes an entry associated with that particular individual with only default values (e.g., “−1”) to the right of that column. For example, manager M2 is two levels down from the top-most level, since row 506 includes a value in column 2 associated with manager M2, with default values “−1” to the right of column 2.

Referring back to FIG. 4, at step 410, the processor aggregates one or more metrics associated with the individual entity. In one embodiment, the processor aggregates metrics for each individual that directly reports to the selected individual entity (i.e., one level deep in the hierarchy). In other embodiments, the processor aggregates metrics for a first set the individual entities that directly report to the selected individual entity and metrics for a second set individual entities that that directly report to the individual entities in the first set (i.e., two levels deep in the hierarchy from the selected individual entity), metrics for all of the individual entities that are below a particular individual entity in the hierarchy (i.e., all levels below in the hierarchy), or metrics for any number of layers below the selected individual entity in the hierarchy. Some entities are aggregated as a summation, e.g., head count of direct reports. Other entities may be aggregated as an average, e.g., average salary of direct reports. Still other entities may be aggregated using any technically feasible aggregation technique.

At step 412, the processor causes the one or more metrics to be displayed on a display device. Depending on the metric, each metric can specify its output type. Metrics may be positive or negative (e.g., retention and attrition) and visualization rules can specify the sort order based on the metric. In some embodiments, visualization rules can also specify the color coding based on metric value. For example, a “used disk space” percentage metric can be specified as 0% to 70% shown in green, 71% to 90% shown in yellow, and 91% to 100% shown in red.

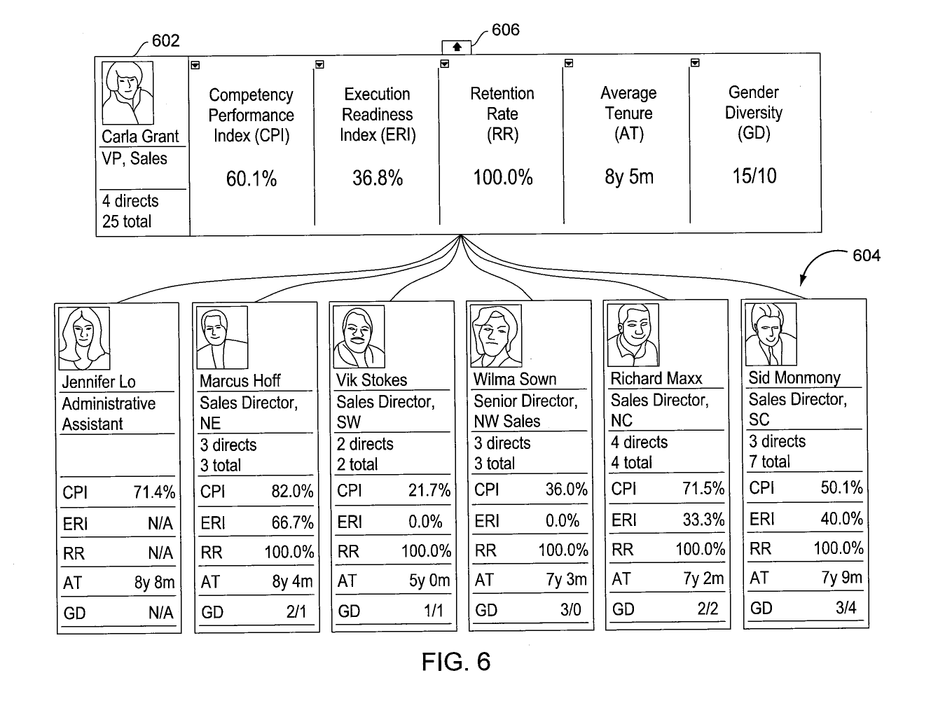

FIG. 6 is a screenshot illustrating a graphical user interface (GUI) for displaying aggregated values associated with one or more metrics, according to one embodiment of the invention. As shown, a particular individual entity 602 in the hierarchy is selected. In the example shown, the selected individual entity 602 manages six other individuals. Five different metrics are aggregated in the example shown in FIG. 6, including Competency Performance Index (CPI), Execution Readiness Index (ERI), Retention Rate (RR), Average Tenure (AT), and Gender Diversity (GD). These examples do not limit the scope of embodiments of the invention, and any other technically feasible metrics may also be aggregated.

As described, the user can navigate up and down in the hierarchy to aggregate metrics associated with different individual entities. For example, the user can navigate up the hierarchy by selecting the arrow 606, and may navigate down the hierarchy by selecting one of the subordinates 604 to be the “selected” individual entity. In other embodiments, a slider may be provided that allows the user to more quickly navigate through multiple levels of the hierarchy.

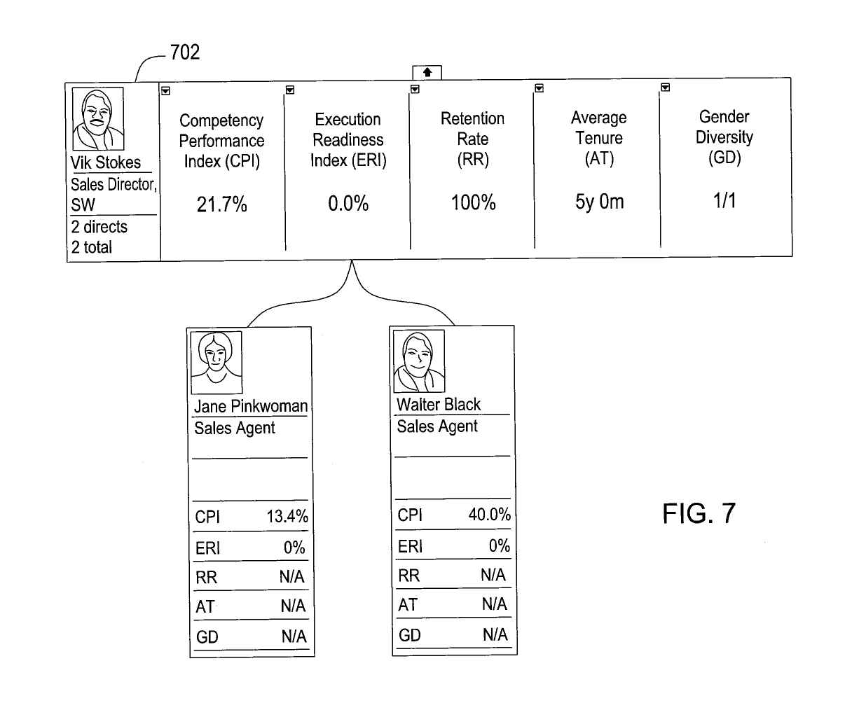

FIG. 7 is a screenshot illustrating a GUI for displaying aggregated values associated with one or more metrics after navigating to another level of the hierarchy, according to one embodiment of the invention. As shown, the individual entity 702 whose metrics are aggregated is changed to “Vik Stokes.” In FIG. 6, Vik Stokes was one of the subordinates to individual entity 602 (i.e., “Carla Grant”). A user navigated down the hierarchy by selecting Vik Stokes to be the individual entity whose metrics are aggregated. In one example, the user may have clicked on Vik Stokes in the GUI shown in FIG. 6, which caused the metrics associated with the subordinates of Vik Stokes to be displayed in the GUI, as shown in FIG. 7.

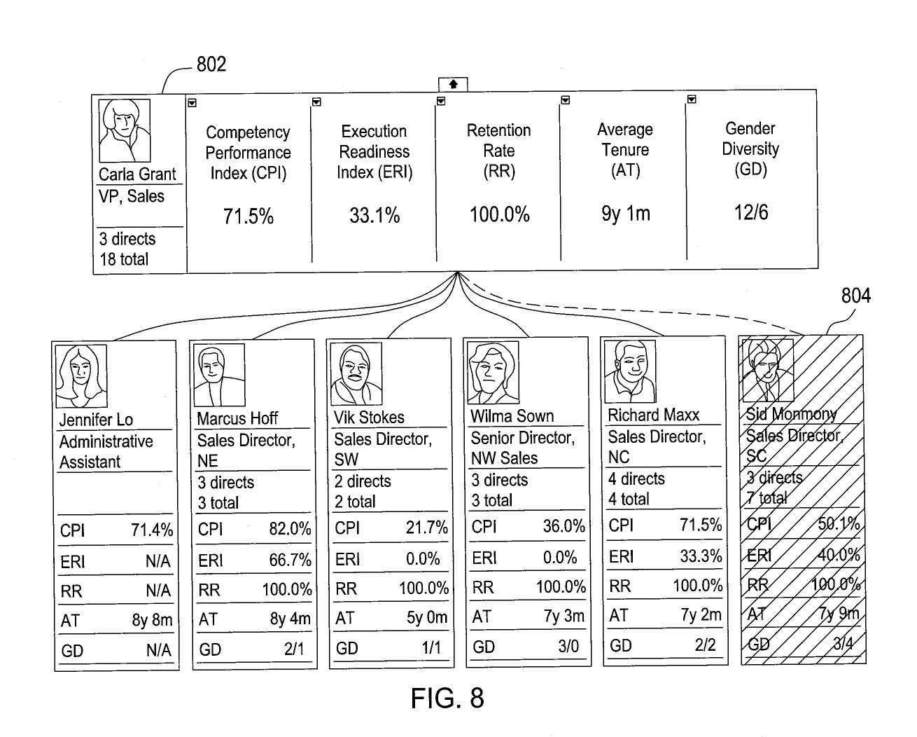

FIG. 8 is a screenshot illustrating a GUI for displaying aggregated values associated with one or more metrics after removing an individual entity from the hierarchy, according to one embodiment of the invention. As shown, the individual entity 804 is removed from the hierarchy. Accordingly, the aggregated metrics associated with individual entity 802 are dynamically updated to be consistent with the updated hierarchical organization. As described herein, a user may dynamically update the hierarchical tree to move individuals in the hierarchical tree, add individual entities to the hierarchical tree, or remove individual entities from the hierarchical tree. The metric navigator may also be configured to dynamically update the metrics in response to updating the individual entities included in the hierarchical tree. In some embodiments, the dynamic update technique can also be automated. For example, when changes need to be made to the hierarchical tree to satisfy various criteria (e.g., cut backs, new hires, salary issues, etc.), the metric navigator can automatically determine a new organizational structure of the individual entities in the hierarchical tree that satisfies the criteria.

In sum, embodiments of the invention provide a software framework for hierarchically organizing individuals or other objects. For example, the software framework may be configured to hierarchically organize employees at a company. One embodiment provides a technique to aggregate one or more metrics associated with the individuals or objects and display the results in a user-friendly manner.

Advantageously, embodiments of the invention allow users to quickly and easily aggregate one or more metrics associated with a hierarchical structure. Additionally, the dynamic nature of embodiments of the invention allows the aggregated metric data to be up-to-date. Additionally, since embodiments of the invention are configurable, applications that implement embodiments of the invention can be tailored to fit the needs of a wide range of different users. For example, the number of levels to aggregate can be configurable or additional metrics can be added in the future.

Various embodiments of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments and numerous specific details are set forth to provide a more thorough understanding of the invention. Persons skilled in the art, however, will understand that various modifications and changes may be made thereto without departing from the broader spirit and scope of the invention. The foregoing description and drawings are, accordingly, to be regarded in an illustrative rather than a restrictive sense.

What is claimed is:

1. A method for generating a user interface that includes organizational data, comprising:
receiving data associated with a hierarchical organization;
receiving individual entity information associated with nodes included in the hierarchical organization;
receiving a selection of a first individual entity;
aggregating one or more metrics associated with the individual entity; and
causing the one or more metrics to be displayed on a display device.

2. The method of claim 1, further comprising:
modifying an arrangement of the nodes included in the hierarchical organization in response to a first input; and
dynamically updating the one or more metrics associated with the individual entity.

3. The method of claim 1, wherein aggregating the one or more metrics is based on a metric calculation formula.

4. The method of claim 1, wherein aggregating the one or more metrics comprises performing a summation operation or an averaging operation.

5. The method of claim 1, wherein aggregating a first metric comprises calculating an aggregated value for individual entities one level below the first individual entity in the hierarchical organization.

6. The method of claim 1, wherein the number of levels used in aggregating the one or more metrics is user-configurable.

7. The method of claim 1, wherein the one or more metrics comprise process metrics associated with one or more items that have a start and an end, or static metrics associated with statistics about an individual entity.

8. The method of claim 1, wherein the hierarchical organization comprises a corporation and the individual entities comprise employees of the corporation.

9. A computer-readable storage medium storing instructions that, when executed by a processor, cause a computing device to generate a user interface that includes organizational data, by performing the steps of:
receiving data associated with a hierarchical organization;
receiving individual entity information associated with nodes included in the hierarchical organization;
receiving a selection of a first individual entity;
aggregating one or more metrics associated with the individual entity; and
causing the one or more metrics to be displayed on a display device.

10. The computer-readable storage medium of claim 9, further comprising:
modifying an arrangement of the nodes included in the hierarchical organization in response to a first input; and
dynamically updating the one or more metrics associated with the individual entity.

11. The computer-readable storage medium of claim 9, wherein aggregating the one or more metrics is based on a metric calculation formula.

12. The computer-readable storage medium of claim 9, wherein aggregating the one or more metrics comprises performing a summation operation or an averaging operation.

13. The computer-readable storage medium of claim 9, wherein aggregating a first metric comprises calculating an aggregated value for individual entities one level below the first individual entity in the hierarchical organization.

14. The computer-readable storage medium of claim 9, wherein the number of levels used in aggregating the one or more metrics is user-configurable.

15. The computer-readable storage medium of claim 9, wherein the one or more metrics comprise process metrics associated with one or more items that have a start and an end, or static metrics associated with statistics about an individual entity.

16. The computer-readable storage medium of claim 9, wherein the hierarchical organization comprises a corporation and the individual entities comprise employees of the corporation.

17. A computer system, comprising:
a processor; and
a memory storing instructions that when executed by the processor cause the computer system generate a user interface that includes organizational data, by performing the steps of:
receiving data associated with a hierarchical organization,
receiving individual entity information associated with nodes included in the hierarchical organization,
receiving a selection of a first individual entity,
aggregating one or more metrics associated with the individual entity, and
causing the one or more metrics to be displayed on a display device.

18. The computer system of claim 17, wherein aggregating the one or more metrics comprises performing a summation operation or an averaging operation.

19. The computer system of claim 17, wherein the number of levels used in aggregating the one or more metrics is user-configurable.

20. The computer system of claim 17, wherein the one or more metrics comprise process metrics associated with one or more items that have a start and an end, or static metrics associated with statistics about an individual entity.
